(19) United States
(12) Patent Application Publication
(10) Pub. No.: US 2026/0357878 A1
(43) Pub. Date: Nov. 12, 2026

(54) HIGH-OFFSET BELT TENSIONER WITH COUNTERBALANCE TORSION SPRING FORCE AND A PLASTIC SPRING COVER

(71) Applicant: MUVIQ USA, LLC, Roseville, MI (US)

(72) Inventor: Anthony E. Lannutti, Fayetteville, AR (US)

(73) Assignee: MUVIQ USA, LLC, Roseville, MI (US)

(21) Appl. No.: 19/299,694

(22) Filed: Aug. 14, 2025

Related U.S. Application Data
(60) Provisional application No. 63/683,790, filed on Aug. 16, 2024.

(51) Int. Cl. F16H 7/12; F16H 7/08

(52) U.S. Cl. CPC F16H 7/1281; F16H 2007/081

(57) ABSTRACT

High-offset belt tensioners have an end plate having a bore therethrough, a pivot tube with a first end fixedly connected in the bore of the end plate and a second end having an annular cup, an arm seated over the annular cup of the pivot tube for rotation relative thereto, and a flat wire torsion spring with its inner spring hook attached to the pivot tube and its outer spring hook attached to the arm at a position that counterbalances a hub load force acting in a first plane. The flat wire torsion spring biases the arm in a belt engaging direction and applies a spring force acting on the arm in a second plane. A direction of the spring force acting on the arm stays in the same location with respect to the arm and moves with the arm throughout its entire sweep in the belt engaging direction.

### RELATED APPLICATIONS

This application claims the benefit of U.S. Provisional Application 63/683,790, filed Aug. 16, 2024, which is incorporated herein by reference in its entirety.

### TECHNICAL FIELD

The present invention relates generally to high-offset belt tensioners and more particularly to a high-offset belt tensioner with a flat wire spring having its outer spring hook operatively connected to the arm of the belt tensioner and the inner spring hook operatively connected to the support base, with the outer spring hook at a position that counterbalances the hub load force with the torsion spring force and having a plastic spring cover.

### BACKGROUND

A traditional flat wire ZED-style belt tensioner design has the inner spring hook attached to the arm arbor, which is seated around a pivot tube defined by a spring case and the outer spring hook is attached to the exterior wall of the spring case, such as described in U.S. Pat. Nos. 8,852,042 and 5,354,242. In this design, the inner portion of the spring moves with the arm (i.e., winds and unwinds with movement of the arm) while the outer hook is stationary since it is connected to a stationary member of the belt tensioner, i.e., the spring case. Here, the direction of the spring force acting on the arm stays in the same location with respect to the spring case because the spring case is mounted to a non-rotatable member, such as an engine component or engine mount. As such, the direction of the spring force is directly on the pivot. As the tensioner arm moves from a free arm position to an install position, the direction of the force does not change. The spring winds onto the arm arbor of the spring case, which defines the pivot point for the arm and as such the force(s) always push inward on the pivot. Then, as the spring bushing wears over time, the axial spring force will urge and move the arm away from the belt sheave. In this traditional belt tensioner, a large bushing is needed on the pivot tube to reduce the pressure and improve alignment control therein.

There is a need for a cost effective and durable belt tensioner in which the spring force is moved radially outward away from the pivot to provide a better mechanical advantage to counterbalance the torsion spring force and improve wear over the lifetime of the belt tensioner.

### SUMMARY

High-offset belt tensioners have an end plate having a bore therethrough, a pivot tube with a first end fixedly connected in the bore of the end plate and a second end having an annular cup, an arm seated over the annular cup of the pivot tube for rotation relative thereto, and a flat wire torsion spring with its inner spring hook attached to the pivot tube and its outer spring hook attached to the arm at a position that counterbalances a hub load force acting in a first plane. The flat wire torsion spring biases the arm in a belt engaging direction and applies a spring force acting on the arm in a second plane. A direction of the spring force acting on the arm stays in the same location with respect to the arm and moves with the arm throughout its entire sweep in the belt engaging direction.

In a first aspect of the disclosed embodiments, high-offset belt tensioners have an end plate having a bore therethrough, a pivot tube with a first end fixedly connected in the bore of the end plate and a second end having an annular cup, an arm seated over the annular cup of the pivot tube for rotation relative thereto, and a flat wire torsion spring with its inner spring hook attached to the pivot tube and its outer spring hook attached to the arm at a position that counterbalances a hub load force acting in a first plane. The flat wire torsion spring biases the arm in a belt engaging direction and applies a spring force acting on the arm in a second plane. A direction of the spring force acting on the arm stays in the same location with respect to the arm and moves with the arm throughout its entire sweep in the belt engaging direction. The arm typically has a pulley mount defining a pully rotation axis, which is offset axially from the pivot tube because the tensioner is a high-offset tensioner. Moreover, the first plane is axially offset from a plane of the spring force.

In various embodiments, the end plate may be a powdered metal component and the pivot tube may be a cast aluminum component. In some embodiments, the bore of the end plate may be a broached bore. In certain embodiments, the high-offset belt tensioner may include a spring cover having an annular main body with a radially inward flange at a first end thereof. The annular main body may define an open slot and may be seated over the flat wire spring with the outer spring hook seated in the open slot. The spring cover may be a plastic component. The plastic may be a glass-filled nylon. The annular main body of the spring cover may be press-fit into the arm for rotation therewith and the radially inward flange may have a contact seal against the upper surface of the end plate. The radially inward flange may be angled away from the annular main body. The high-offset belt tensioner may further comprise an annular lip seal seated between a rim of the spring cover and the arm for rotation therewith and having a lip flange in operative engagement with the annular cup of the pivot tube.

In additional embodiments, the high-offset belt tensioner may include a pivot bushing seated between an interior surface of the arm and an exterior surface of the annular cup of the pivot tube. The pivot bushing may have a key that may be keyed to the annular cup of the pivot tube. The pivot bushing may have a longitudinal slit therethrough positioned through the key. The pivot bushing may have a radially inward extending flange seated between an end surface of the annular cup of the pivot tube and a pivot-tube facing surface of the arm.

In other embodiments, the high-offset belt tensioner may further comprise a pivot bushing seated between an interior surface of the annular cup and a cup-facing surface of the arm seated inside the annular cup. The slit may be positioned through the key of the pivot bushing. The pivot bushing may have a radially outward extending flange seated between an end surface of the annular cup of the pivot tube and a pivot-tube facing surface of the arm. The pivot bushing may have a key that may be keyed to the arm. The pivot bushing may have a longitudinal slit therethrough positioned through the key of the pivot bushing. The exterior surface of the annular cup may have an arm travel limiting feature defining a preselected number of degrees for a maximum rotation of the arm and the arm may have a mating feature engaged with the arm travel limiting feature.

In further embodiments, the high-offset belt tensioner may further comprise a damper bushing in operative engagement with the arm by an arm plate operatively engaging the second end of the pivot tube. A wear surface of a main body of the damper bushing may be seated against the arm plate and the main body may include a plurality of troughs for retention of grease. The damper bushing and arm plate may be seated in a cup defined by the arm. The high-offset belt tensioner may further comprise a rubber dust cover press-fit into the cup of the arm.

In all embodiments, the arm may have a radially protruding enclosure in its radially outermost surface at a position that locates the enclosure in a protective orientation over the outer spring hook. Additionally, in all embodiments, the arm may have an arm travel limiting feature defining a preselected number of degrees for a maximum rotation of the arm in a cup-facing surface of a cup-shaped portion seated in the annular cup of the pivot tube and the annular cup may have a mating feature engaged with the arm travel limiting feature. Further, in all embodiments, the annular cup may have an arm travel limiting feature in the bottom surface thereof that defines a preselected number of degrees for a maximum rotation of the arm and the arm may have a mating feature engaged with the arm travel limiting feature.

### BRIEF DESCRIPTION OF THE DRAWINGS

FIG. 1 is a top perspective view of a high-offset belt tensioner with a rubber plug seated in the arm.

FIG. 2 is an exploded, top perspective view of a first embodiment of a high-offset belt tensioner.

FIG. 3 is an assembled longitudinal cross-section of the high-offset-belt tensioner of FIG. 2.

FIG. 4 is a transverse cross-sectional view taken along line 4-4 shown in FIG. 3.

FIG. 5 is a transverse cross-sectional view taken along line 5-5 shown in FIG. 3.

FIG. 6 is a top perspective view of a pivot tube of the first embodiment.

FIG. 7 is a bottom perspective view of the pivot tube of the first embodiment.

FIG. 8 is a bottom plan view of the pivot tube of the first embodiment.

FIG. 9 is a bottom plan view of the base plate of the first embodiment.

FIG. 10 is a longitudinal cross-sectional view taken along line 10-10 in FIG. 9.

FIG. 11 is an enlarged view of the portion of the belt tensioner inside the dashed circle in FIG. 3 showing the position of the annular lip seal.

FIG. 12 is an enlarged longitudinal, cross-section of a portion of the annular lip seal.

FIG. 13 is a longitudinal cross-sectional view of the spring cover looking toward the open slot.

FIG. 14 is an end view of the first embodiment showing the outer spring hook connected to the arm.

FIG. 15 is a transverse cross-sectional view through the flat wire spring.

FIG. 16 is a bottom plan view of the pivot bushing of the first embodiment.

FIG. 17 is an exploded, top perspective view of a second embodiment of a high-offset belt tensioner.

FIG. 18 is a longitudinal cross-sectional view of the second embodiment.

FIG. 19 is a transverse cross-sectional view taken along line 19-19 shown in FIG. 18.

FIG. 20 is a transverse cross-sectional view taken along line 20-20 shown in FIG. 18.

FIG. 21 is a transverse cross-sectional view of an alternate embodiment for the arm travel limiting features.

FIG. 22 is a bottom perspective view of a dust cover.

FIG. 23 is a top perspective view of the dust cover of FIG. 22.

FIG. 24 is a central longitudinal cross-sectional view of the dust cover.

### DETAILED DESCRIPTION

The following detailed description will illustrate the general principles of the invention, examples of which are additionally illustrated in the accompanying drawings. In the drawings like reference numbers indicate identical or functionally similar elements.

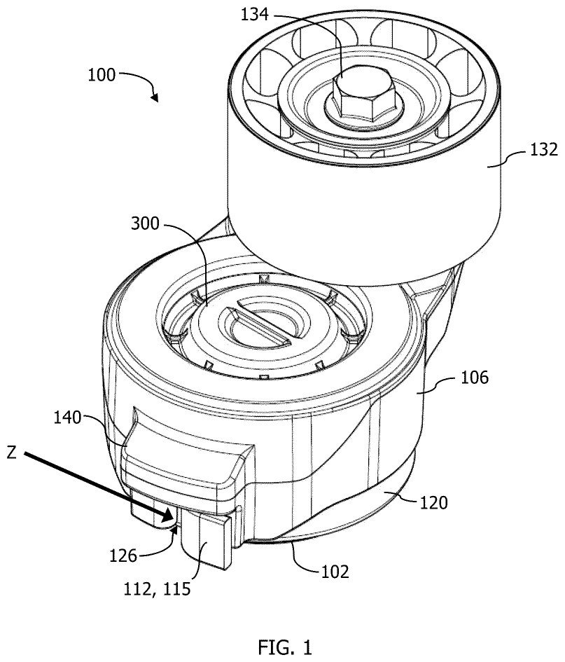

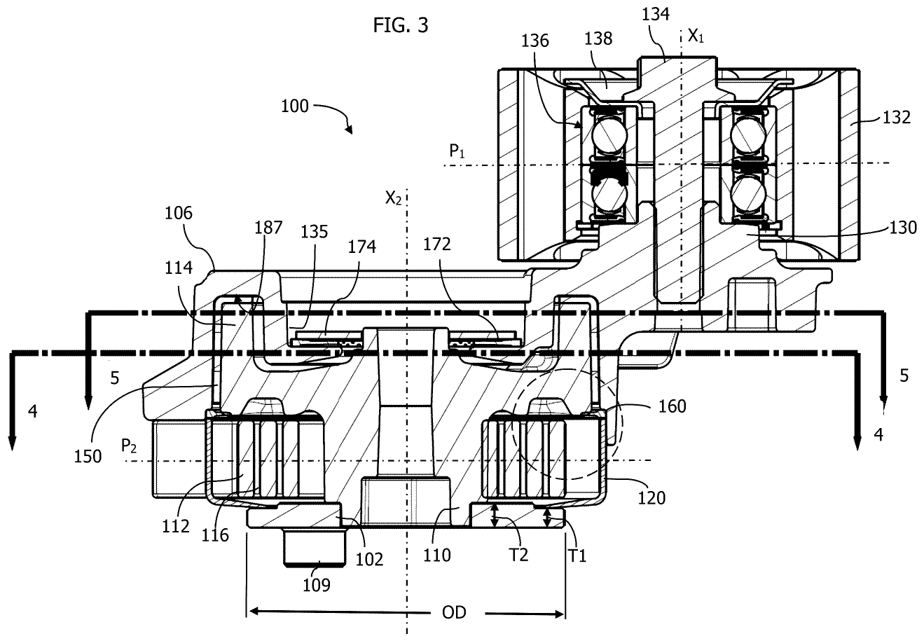

Referring to FIGS. 1-3, a first embodiment of a high-offset belt tensioner 100 is exemplified, which provides a predetermined amount of tension upon a belt of a belt system, such as a transmission belt of an engine system. A high-offset belt tensioner is also referred to as a Zed type belt tensioner. As labeled in FIG. 3, the high-offset belt tensioner has a plane (P₁) coincident with a hub load force that is transverse to the pulley rotation axis (X₁), which is axially offset above a plane (P₂) coincident with a torsion spring force (a plane of the spring force) of the tensioner 100. The tensioner 100 includes an arm 106 pivotally mounted to a pivot tube 110 defining a pivot axis (X₂) about which the arm pivots. The pivot tube 110 has a first end 111 fixedly seated in a bore 104 of an end plate 102, which collectively define the nonrotatable portion of the belt tensioner and has a second end 113 comprising an annular cup 114. More specifically, the arm 106 is seated over the annular cup 114 for rotation relative thereto. A torsion spring 112 is operatively coupled between the arm 106 and the pivot tube 110 to bias the arm in a belt tensioning direction. The arm 106 has a pulley mount 130 defining pivot axis (X₁) for a pully 132. The pivot axis (X₁) is offset axially from the pivot axis (X₂) defined by the pivot tube.

A pulley 132 is mounted for rotation to the pully mount 130 of the arm 106 by a bolt 134 extending through the hub of the pulley 132 and into a threaded bore 131 of the pully mount. The pulley 132 is preferably journaled to the pulley mount 130 by a roller bearing 136 (best seen in FIG. 3). A dust cover 138 in the shape of a washer is coaxially mounted between the roller bearing 136 and the head of the bolt 134 to protect the roller bearing 136 from debris and contamination. To seal the bottom of the pulley 132 against debris and contamination an annular seal, such as a V-ring, X-ring, or O-ring seal can be seated in operative engagement with the roller bearing 136 and the pulley mount 130 of the arm 106.

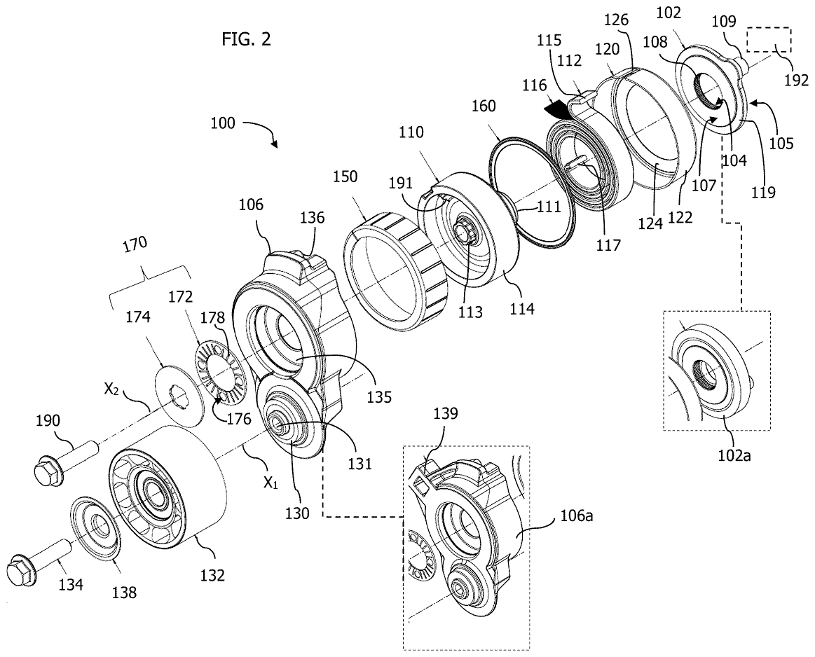

The torsion spring 112 applies a torsional spring force on the arm 106 in the direction shown by arrow Z (FIG. 1) representing a belt engaging direction, such that the end of the arm having the pulley 132 applies a corresponding tension force upon a belt. The torsion spring 112 may be manufactured from steel, but other suitable alternative materials (or combination of materials/components) to construct such components are also contemplated. Here, the torsional spring 112 is a flat wire spring, that is operatively coupled between the arm 106 and the pivot tube 110 has an inner spring hook 117 attached to the pivot tube 110 and an outer spring hook 115 attached to the arm at a position that counterbalances a hub load force acting in the first plane (P₁). This construction enables the outer portion of the flat wire spring 112 to move with the arm while the inner spring hook 117 is attached to the stationary, non-rotatable pivot tube 110 of the support base 108. The flat wire spring 112 biases the arm 106 in a belt engaging direction and applies a spring force acting on the arm 106 in the second plane (P₂). Since the outer spring hook 115 is attached to the arm 106, a direction of the spring force acting on the arm 106 stays in the same location with respect to the arm and moves with the arm throughout its entire sweep in the belt engaging direction. The outer and inner spring ends 115, 117 can be bent to define hooks, tangs, etc. to enhance the attachment of the spring to the respective pivot tube and arm. An advantage of moving the spring force away from the pivot tube and away from the pulley is to provide a better mechanical advantage to balance out the force applied at the pulley 132. As the spring moves, the direction of the force and magnitude will adjust as well. Also, there is versatility in that the abutment location 136 (FIG. 2) of the arm 106 that receives the outer spring hook 115 can be adjusted depending upon what is required to balance the forces in the high-offset belt tensioner. The abutment location 136 can be defined by the portion of the arm define an opening 126 therein.

The flat wire spring 112 can include a spring tape 116 positioned between the coils thereof as shown in FIGS. 2 and 3. The spring tape 116 is coiled in a juxtaposed position with the flat wire spring 112, such that the spring tape 116 is between the coils of the flat wire spring and optionally, can be long enough to be present between the flat wire spring 112 and the interior wall(s) of the arm 106. The use of spring tape 116 reduces frictional wear of the spring or other negative effects of friction due to coil-to-coil contact of the spring.

With reference to FIGS. 1-3 and 9-10, the end plate 102 has the central bore 104 therethrough, an exterior surface 105 opposite an interior surface 107, oriented in the axial direction, and has a registration pin 109 extending from the exterior surface 105 in an axial direction. The end plate 102 can be a powdered metal or metal alloy component, which is cheaper and easier to manufacture, and has better lead time from a supply chain perspective. The use of powdered metal or metal alloy enables the central bore 104 to undergo a broaching process to form teeth 108 therein, i.e., the end plate 102 has a broached bore. The powdered metal or metal alloy can be powdered metal steel. In one embodiment, the powdered metal is a steam treated copper steel. The interior surface 107 of the end plate 102 can include a peripheral plateau 119 that has a thickness (T1) that is less than a thickness (T2) more proximate the central bore 104, the thickness being label in FIGS. 3 and 10. The junction of the registration pin 109 to the exterior surface 105 of the end plate 102 can include a chamfer 109a that flares outward away from the registration pin in a direction toward the exterior surface 105. As shown in FIGS. 3 and 9, the end plate 102 has an outer diameter (OD) that is less than a respective outer diameter of the annular cup 114 of the pivot tube and of the arm 106. The end plate provides the advantage of being a cheaper and easier to source part that can have the registration pin, i.e., its angular position, adjusted easily without changing any of the other components. As represented in the first dashed box in FIG. 2, the end plate 102a can have a thickness selected as appropriate for the end application. The thickness of the end plate can be as thin as 5 mm and as thick as needed to achieve the desired application offset target.

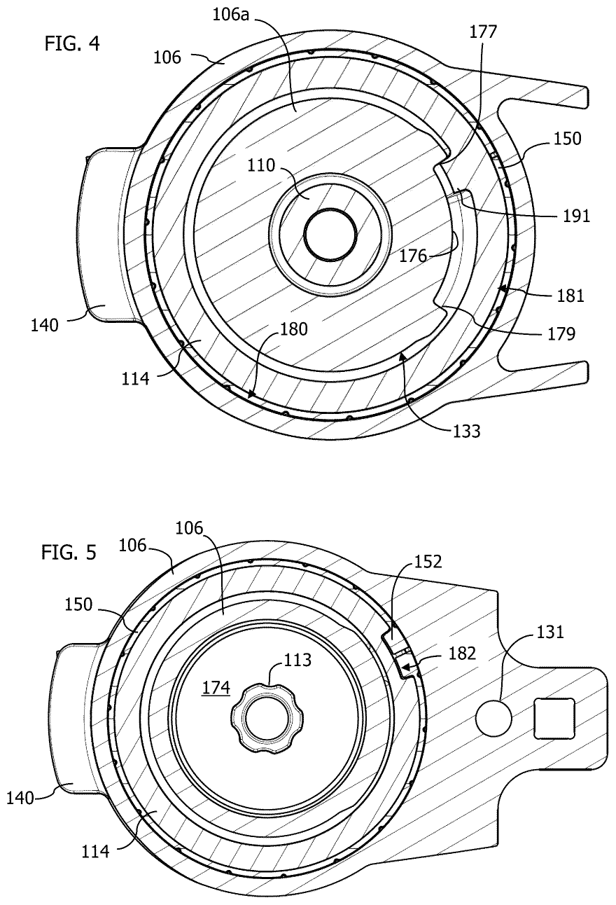

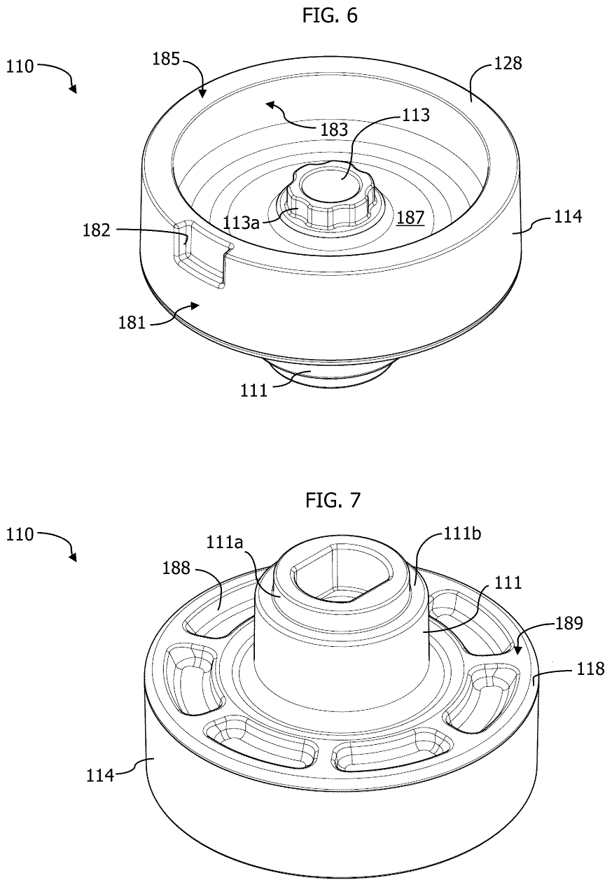

Referring now to FIGS. 2-3 and 6-8, the pivot tube 110 a first end 111 configured to be seated in a bore 104 of the end plate 102 and a second end 113 comprising an annular cup 114. The first end 111 can have a terminus 111a of reduced diameter such that a shoulder 111b is defined, which can sit against the upper surface 107 of the end plate 102, thereby adding additional stability to the pivot tube. The second end 113 terminates with a splined projection 113a in the bottom of the annular cup 114. The splined projection 113a is configured to receive the arm plate 174 for a fixed connection thereto. The annular cup 114 has an exterior surface 181 and an interior surface 183 opposite thereof in the radial direction, an upper end surface 185 at the rim of the annular cup, an interior bottom surface 187, and an exterior bottom surface 189 in the axial direction. The bottom surface 189 of the annular cup 114 can include an annular seat 118 recessed into the periphery thereof configured to receive a portion of a sealing member, such as a lip seal described in more detail below. The annular cup 114 can include a plurality of troughs 188 in the exterior bottom surface 189 thereof. The plurality of troughs can reduce the weight of the pivot tube. As best seen in FIG. 6, the pivot tube 110 has a keyway 182 shaped to receive a key positioned in the exterior surface 181.

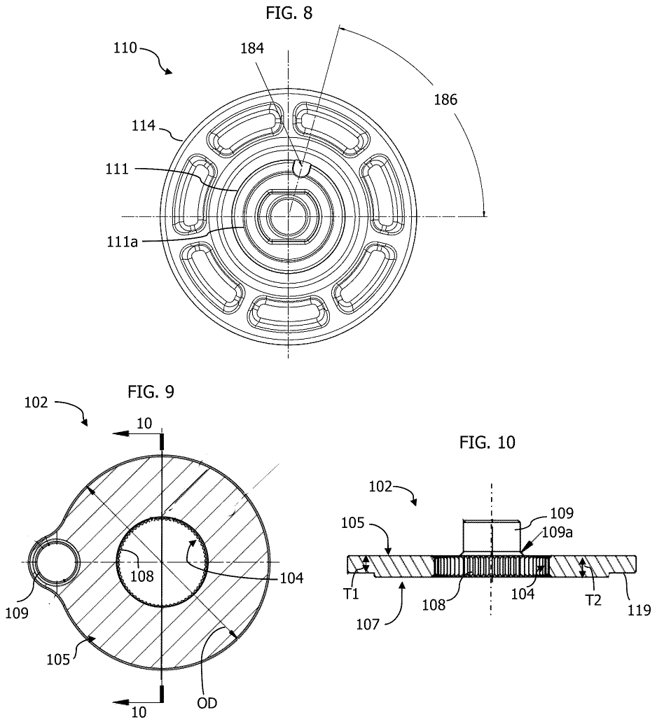

Turning now to FIG. 8, the pivot tube 110, more specifically the first end 111 of the pivot tube between the terminus 111a and the annular cup 114, includes a spring abutment feature, shown here as an elongate recess 184 extending in the axial direction, i.e., a vertical slot oriented parallel to the pivot axis (X₂) configured to receive the inner spring end 117. The elongate recess 184 is positioned at a pre-selected angular position 186, which can be selected relative to the engine application and desired torque to be imparted to the tensioner by the torsion spring 112. One advantage of this embodiment is that pivot tube can be manufactured as a blank and the spring abutment feature 184 can be machined into the pivot tube 110 thereafter to whatever specification is needed, e.g., selected angular position 186 relative to the position of the registration pin 109. Changing the angular position 186 or the position of the registration pin 106 changes the nominal position of the tensioner when mounted in an engine system, thereby changing the torque.

Looking to FIG. 4, the pivot tube 110, more specifically the annular cup 114 thereof includes a protrusion 191 extending into the interior of the annular cup. The protrusion 191 is configured to fit within an arm travel limiting slot 176 that is recessed into radial pivot-tube facing surface 133 of a central portion 106a of the arm 106. The arm travel limiting slot 176 is defined by a first stop shoulder and a second stop shoulder 177, 179 spaced a preselected number of degrees of rotation about the pivot axis (X₂). The protrusion 191 of the pivot tube 110 sits in the arm travel limiting slot 176 of the arm in the assembled position and can be positioned to start against one of the first and second stop shoulders 177, 179.

The arm 106 and pivot tube 110 can be manufactured from a die-cast metal. In one embodiment, the die-cast metal or metal alloy comprises aluminum. In all embodiments, the die-cast metal or metal alloy is a softer metal than the powdered metal utilized for the end plate 102 such that the teeth 108 in the bore 104 thereof can bite into the softer metal or metal alloy of the pivot tube 110 to form a fixed connection for these stationary components of the tensioner. In an alternate embodiment, as represented in the second dashed box in FIG. 2, the arm 106a can optionally include a tool receptacle 139.

In all embodiments, the belt tensioners disclosed herein include a pivot bushing 150 operatively seated between the arm 106 and the pivot tube 110. In the first embodiment, with reference to FIGS. 3-8 and 16, the pivot bushing 150 is seated between an interior surface 180 of the arm 106 and an exterior surface 181 of the annular cup 114 of the pivot tube 110. The pivot bushing 150 has a key 152 (a radially inward extending tab in FIG. 16) that is keyed to the annular cup 114 of the pivot tube 110. The pivot tube 110 has a keyway 182 shaped to receive the key 152 of the pivot bushing 110, which holds the pivot bushing 150 stationary for the arm 106 to rotate relative thereto. The pivot bushing 150 has an axially extending main body 151 and a radially inwardly extending flange 153. The radially inward extending flange 153 is seated between an end surface 185 (labeled in FIG. 6) of the annular cup 114 of the pivot tube 110 and a pivot-tube facing surface 187 (labeled in FIG. 3) of the arm 106. The pivot bushing 150 has a slit 156 extending axially through the key 152, thereby allowing some expansion thereof. The exterior surface 158 of the main body 151 includes a plurality of axially oriented troughs 159 for retention of grease.

The pivot bushing 150 is typically formed from wear-resistant plastic. The flange 153 acts as a bearing surface and the pivot bushing in its entirety, as best seen in FIG. 3, also acts to seal the tensioner, thereby protecting the torsion spring from external contaminants. While the pivot bushing 150 in this embodiment is a wear-resistant plastic, it is within the scope of the invention to use other suitable bushing materials or bearing structures. The pivot bushing provides a bearing surface for the rotation and translation of elements of the tensioner along and about the pivot axis.

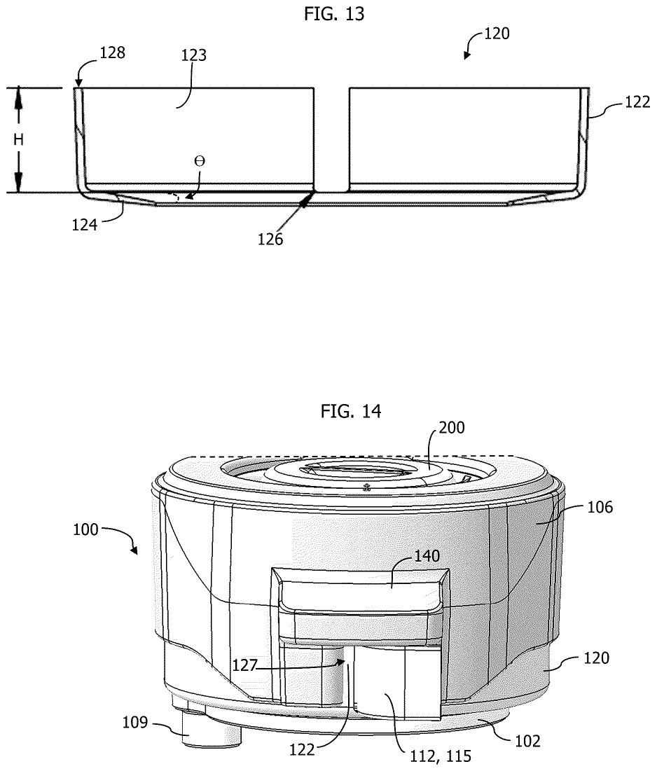

With reference to FIGS. 2, 3, and 13, the belt tensioner 100 can also include a spring cover 120 that has an annular main body 122 with a radially inward flange 124 at a first end thereof. The annular main body 122 has a height (H), an interior surface 123, and defines an open slot 126. The spring cover 122 is seated over the flat wire spring 112 with the outer spring hook 115 seated in the open slot 126. The spring cover 120 can be a plastic component, such as any glass filled nylon or other suitable heat and moisture stabilized material that can handle engine system conditions. In one embodiment, the spring cover is a 30% glass-filled nylon plastic component. In the assembled belt tensioner of FIG. 2, the annular main body 122 of the spring cover 120 is press-fit into the arm 106 for rotation therewith and the radially inward flange 124 has a contact seal against the peripheral plateau 119 of the upper surface 107 of the end plate 102 as best seen in FIG. 3. The radially inward flange 124 can be angled away from the annular main body 122 to aid in forming the contact seal, thereby defining an angle (θ). The angle (θ) is labeled in FIG. 13 and can be in a range of 1° to 15°, preferably about 5°. Angle (Θ) is dependent on the stiffness of the material (plastic) forming the spring cover 120, which impacts the force applied versus wear over time, and the need to maintain the radially inward flange 124 in contact with the end plate 102 throughout the tensioner's entire life.

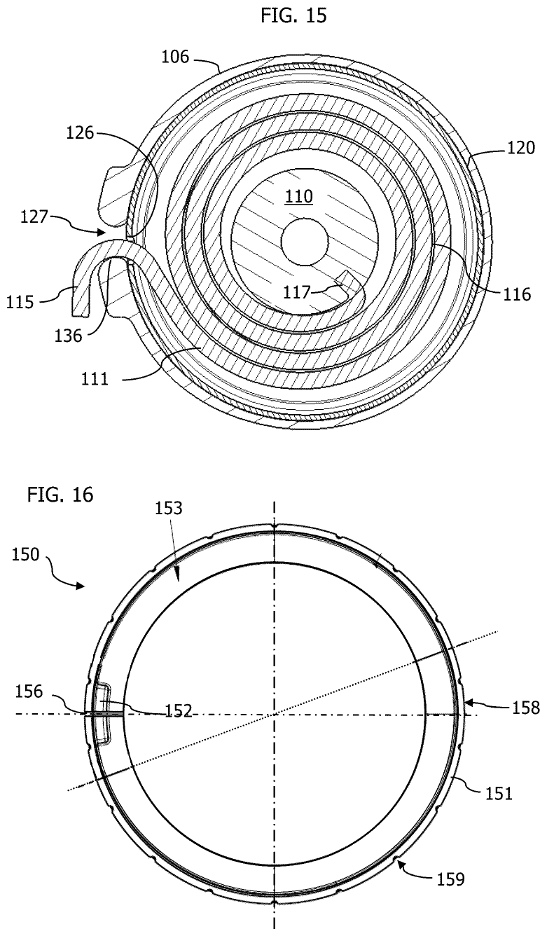

The spring cover 120 provides numerous advantages. It shrouds the spring and prevents contaminants from reaching the spring and pivot bushing, such as dirt and debris. The plastic spring cover is cheaper and easier to source than die-cast parts. Also, the spring cover when made of plastic defines a larger spring cavity than a die cast part, which enables the torsion spring to be a larger spring with higher torque and reduces the overall mass of the belt tensioner. Also, the spring cover 120 eliminates the slot plug (see FIGS. 14 and 15) that is typically used to seal the abutment location 136 of the arm. The open slot 126 in the spring cover 120 is more closely fit to the spring end 115 than the opening 127 in the arm, thereby protecting the spring from contamination.

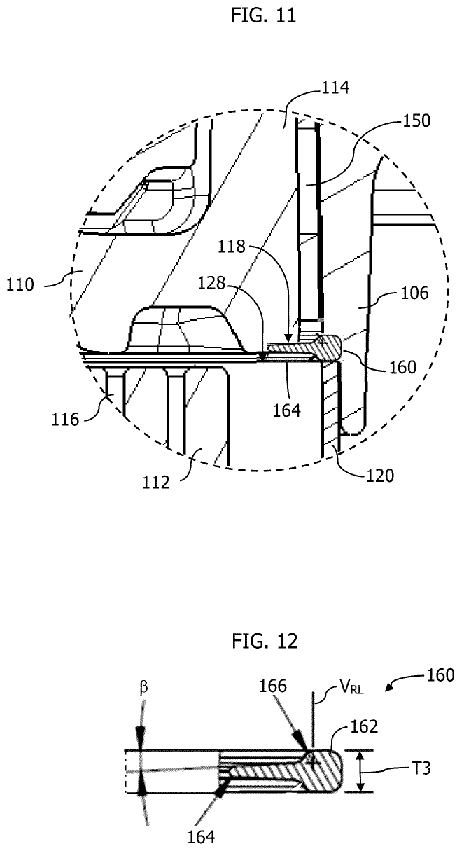

Turning now to FIGS. 11-12 to describe the seal shown inside the dashed circle of FIG. 3, an annular lip seal 160 is seated in compression between a rim 128 of the spring cover 120 and the arm 106 for rotation with the arm, thereby biasing a lip flange 164 into operative engagement (contact) with the bottom surface 189 of the annular cup 114 of the pivot tube 110. The bottom surface 189 of the annular cup 114 can include an annular seat 118 recessed into the periphery thereof. The annual lip seal 160 is positioned below the pivot bushing 150 and protects the pivot bushing from contamination. As best seen in FIG. 12, the annular lip seal 160 has a radially outer annular body 162 having a thickness T3 that has a lip flange 164 extending therefrom. The lip flange 164 extends radially in an inward direction toward the rotational axis X₂. The lip flange 164 is oriented at an angle (β) relative to a vertical reference line (V_{RL}) at the junction of the lip flange to the annular body 162 when at rest on a surface, such as a tabletop. The shape of the annular lip seal 160 and the angle of the lip flange 164 are configured to provide wear laterally during the life of the belt tensioner without loosing contact with the pivot tube.

Referring again to FIGS. 1-3 and 14, the arm 106 has a radially protruding enclosure 140 in its radially outermost surface at a position that locates the enclosure 140 in a protective orientation above and/or around the opening 127 therein, and hence above and/or around the outer spring end 115. In one embodiment, the enclosure 140 has an open bottom, such that the outer spring end 115 are able to be axially seated therein. The opening 127 defines a spring abutment feature 136 against which the outer spring end 115 is operatively seated to bias the arm 106 in the belt tensioning direction.

Turning again to FIGS. 2 and 3, the high-offset belt tensioner 100 includes a damper assembly 170 seated in the cup 135 of the arm 106 in operative engagement with the arm 106 to provide frictional symmetric damping. The damper assembly includes a damper bushing 172 and an arm plate 174 fixedly connected to the splined end 113a of the pivot tube 110. The damper bushing 172 is a radially extending annular plate, the upper surface 176 of which includes an annular wear surface in operative engagement with the arm plate 174 and a plurality of grease grooves 178. The arm plate in a non-deflected state (pre-assembly) can include a plurality of teeth extending radially inwardly from the inner circumferential surface thereof that defines the inner diameter. These teeth become embedded into the outer circumferential surface of the pivot tube at the upper end of the pivot tube to securely attach the damping mechanism to the pivot tube. The arm plate 174,in an exemplary embodiment, is a hardened steel plate and the damper bushing material is typically a wear-resistant plastic. The wear-resistant plastic can be, but is not limited to, all polyamides (PA) including 66 nylon, 6 nylon, 11nylon, 12 nylon, 69 nylon, 612 nylon, and 610 nylon, polyamide 46 nylon; polyethermides (PEI); polysulfones (PSU); polyethersulfones (PES); polyoxymethylenes (POM), or acetals; polyetheretherketones (PEEK); polyphenylene sulfides (PPS); polypthalamides (PPS), or amodels; polyphenylene sulfides (PPO); and amorphous nylons.

The belt tensioner 100 can include a bolt 190 receivable in and through the pivot tube 110 for mounting the belt tensioner in an engine system. As shown in co-pending U.S. application Ser. No. 17/680,541, a bolt retainer 192 can be present to hold the bolt in place (and the components together) until time to install the belt tensioner 100 in the engine system.

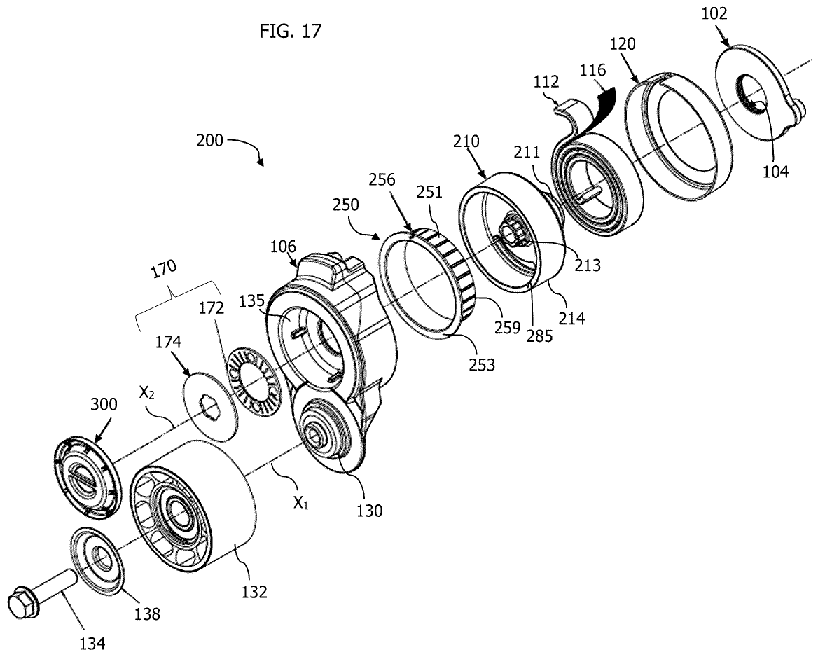

Turning now to the embodiment of FIGS. 17-20, a second embodiment of a high-offset belt tensioner 200 for providing a predetermined amount of tension upon a belt of an engine systems is exemplified. The components in this embodiment that are the same as those of the first embodiment have been marked with the same reference numbers. The details of those components can be found above with respect to the first embodiment. Those features that have been changed or are new have been numbered in the 200s. The tensioner 200 includes an arm 106 pivotally mounted to a pivot tube 210, which defines a pivot axis (X₂) about which the arm pivots, and a torsion spring, here a flat wire spring 112 with a spring tape 116, operatively coupled between the arm 106 and the pivot tube 210. The belt tensioner 200 includes a bolt 190 received in and through the pivot tube 210 for mounting the belt tensioner in an engine system. The pivot tube 210 has a first end 211 fixedly seated in a bore 104 of an end plate 102, which collectively define the nonrotatable portion of the belt tensioner and has a second end 213 comprising an annular cup 214. In this embodiment, the arm 106 is seated over the annular cup 214 for rotation relative thereto but with the pivot bushing 250 seated with its main body 251 inside the annular cup 214 and operatively positioned between the annular cup 214 and the central portion 106a that defines the cup 135 of the arm 106. The arm 106 has a pulley mount 130 offset axially from the first end that defines a pulley rotation axis (X₁). A pulley 132 is mounted for rotation to the pulley mount 130 of the arm 106 in the same manner described above with respect to the first embodiment.

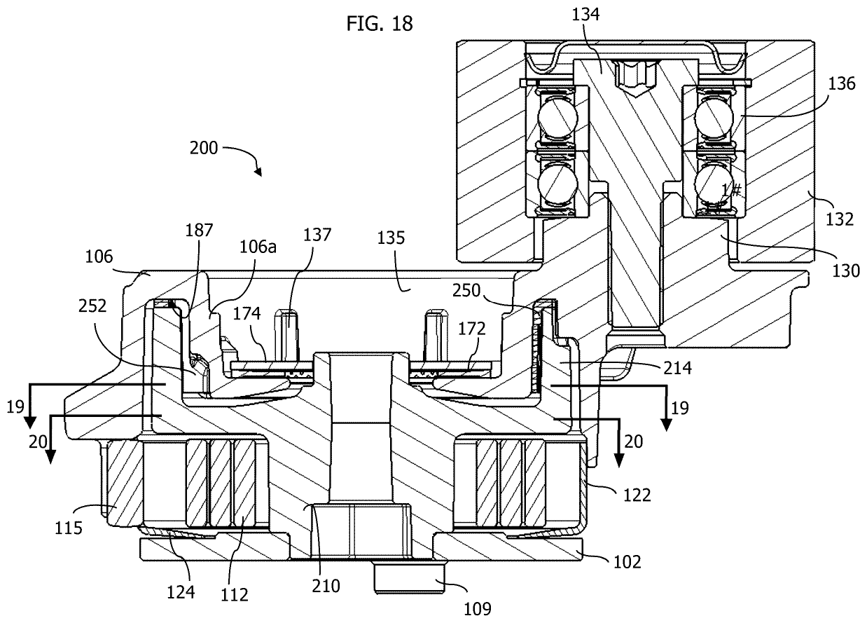

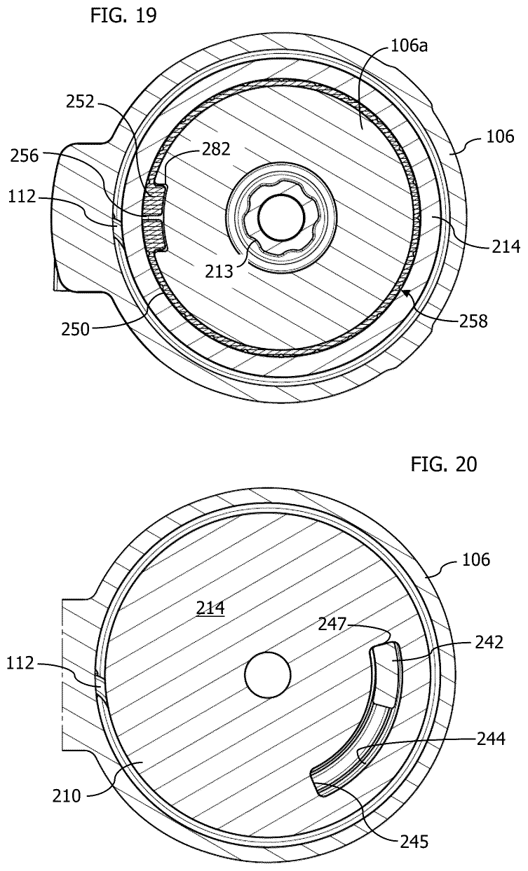

The pivot bushing 250 is essentially the reverse of the pivot bushing 150. Here, the pivot bushing 250 has an axially extending main body 251 and a radially outwardly extending flange 253. The radially outwardly extending flange 253 is seated between an end surface 285 of the annular cup 214 of the pivot tube 210 and a pivot-tube facing surface 187 (labeled in FIG. 18) of the arm 106. The pivot bushing 250 has a slit 256 extending axially through a key 252 (best seen in FIG. 19), thereby allowing some expansion thereof, which is keyed to a keyway 282 of the central portion 106a of the arm for rotation with the arm 106. The exterior surface 258 of the main body 251 includes a plurality of axially oriented troughs 259 for retention of grease.

Referring now to FIG. 20, in this embodiment, the arm limiting travel slot 244 has been moved to the bottom of the annular cup 214 of the pivot tube 210. The arm travel limiting slot 244 is arcuate and defines a preselected number of degrees for a maximum rotation of the arm 106. The arm 106 has a mating feature 242 protruding from a bottom surface of the central portion 106a of the arm, which is seated within with the arm travel limiting slot 244. As used herein, with respect to the components illustrated in FIG. 20, top and bottom are relative to the assembled tensioner, wherein the “bottom” is the surface of the end plate having the registration pin and the “top” is the surface of the arm having the pulley mount.

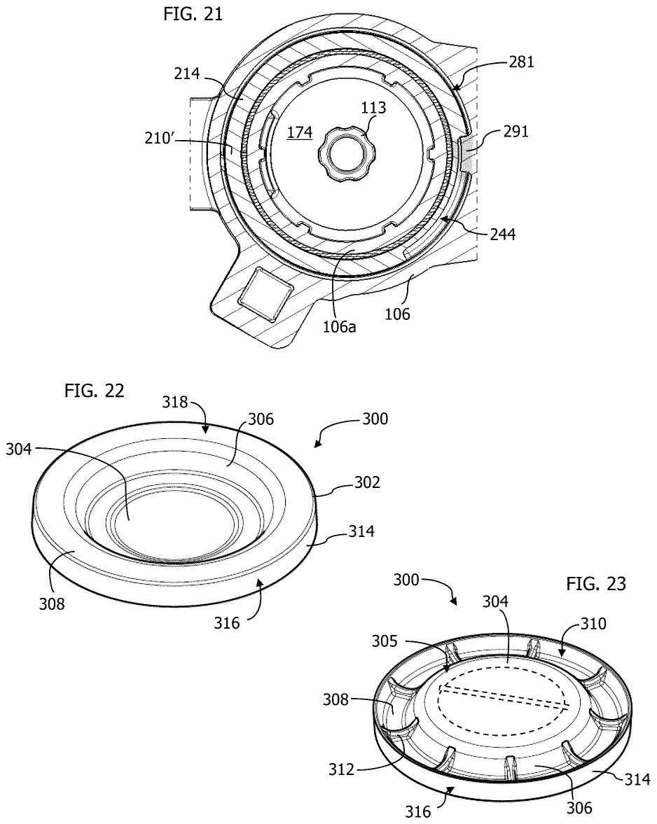

Turning to FIG. 21, an alternate option for the position of the arm limiting travel features is shown for this second embodiment of the belt tensioner 200. Since the pivot bushing 250 is seated inside the annular cup 214 of the pivot tube 210′, the arm limiting travel slot 244 can be in the radially oriented exterior surface 281 of the annular cup and the protrusion 291 mated therein can extend from an interior surface of the arm 106. Otherwise, the features of the arm limiting travel slot 244 and protrusion 291 are as described above with respect to FIG. 4.

Turning now to FIGS. 22-24, a dust cover 300 is shown and described in detail. The dust cover 300 is shown in FIG. 1 (assembled tensioner) and FIG. 17 (exploded view of the tensioner) as being configured to be seated in the cup 135 of the arm 106 with a friction fit utilizing compression of the annular rim 308 thereof, thereby closing the cup and protecting the damper assembly 170 and the interior of the tensioner from environmental contamination, such as dust and debris. The cup 135 of the arm can include a plurality of axially oriented ribs 137 on the interior surface thereof, the upper ends of which define a seat to receive the rubber plug 300. The dust cover 300 is made of or comprises a thermoplastic elastomer, which makes it insertable and removable for access to the bolt that mounts the tensioner to an engine system.

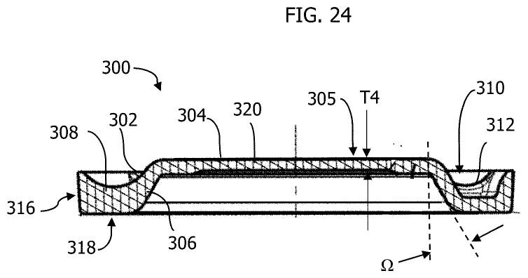

The dust cover 300 has a cap-like structure having a top 304 with an annular flange 306 flared outward away from the top surface 304. As shown in FIG. 24, the top 304 can have a central portion 320 of reduced thickness T4 and the “flare” for the flange is represented by angle (Ω), which is measured relative to a vertical line at the junction of the flange 306 to the top 304. Angle (Ω) is in a range of 20 to 40 degrees, more preferably 30 degrees. The annular flange 306 terminates with a radially extending annular rim 308. The annular rim 308 extends from the annular flange 306 in a manner that defines an annular trough 310 in the upper surface 305 of the dust cover, thereby defining a terminal flange 314 extending in the opposite direction relative to the annular flange 306. The terminal flange 314 defines the outer diameter of the dust cover 300 and a radially facing exterior surface 316. The exterior surface 316 operatively engages the interior surface # of the cup 135 of the arm for rotation therewith. The annular rim 308 also defines the bottom surface 318 of the dust cover 300, which sits on the plurality of axial oriented ribs 137 in the cup of the arm 106 in the assembled tensioner.

As best seen in FIG. 23, the dust cover 300 includes a plurality of ribs 312 extending radially outward from the annular flange 306 to the terminal flange 314. The plurality of ribs 312 are typically spaced apart equally about the diameter of the annular flange 306. Each rib of the plurality of ribs is arcuate in the axial direct, such that each rib is generally C-shaped or U-shaped along the upper surface thereof. While the embodiment of FIGS. 22-24 is shown with nine ribs, the dust cover is not limited thereto. The dust cover 300, as seen in dashed lines in FIG. 23, can optionally have a tool gripping or receiving feature on the top 304 thereof to aid in the insertion and/or removal of the dust cover.

The thermoplastic elastomer may be a polyester elastomer, a styrene butadiene styrene elastomer, a styrene ethylene butylene styrene elastomer, a thermoplastic olefin comprising polypropylene or polyethylene and ethylene propylene diene monomer rubber (EPDM), ethylene propylene rubber (EPR), ethylene octene (EO), or ethylbenzene (EB), a polyurethane elastomer, or mixtures thereof. In one embodiment, the thermoplastic polyester elastomer is suitable for automotive applications. The thermoplastic elastomer is typically one with toughness, resilience, high resistance to creep, impact and flax fatigue resistant, and that retains its properties at elevated temperatures, is resistant to oils and solvents, is flame retardant, and light stable. An example thermoplastic polyester elastomer is available from Dupont under the brand name HYTREL®.

If the rubber plug 300 is omitted, the high-offset belt tensioner may include an annular seal member (not shown) radially, outwardly juxtaposed to the outermost surface of the damper bushing 172 and seated beneath the arm plate 174 to add another barrier against debris and/or contaminants. The annular seal member can be an X-ring, V-ring seal, or O-ring seal.

The belt tensioners discussed herein have numerous advantages, many of which have been already discussed above. The advantage of moving the spring force away from the pivot is to provide a better mechanical advantage to balance the hub load force on the other side. As the spring moves, the direction of the force and magnitude will adjust as well. This design allows the abutment location to be adjusted to balance the forces.

Some additional advantages are provided by the flat wire spring. A flat wire spring is advantageous because it has a lower torque per degree of rotation and less degrees of variation than a round wire spring. A flat wire spring also has less resonance issues than a round wire spring and the use of spring tape between the spring's coils can further reduce noise. Additionally, the flat wire spring reduces the tensioner's axial height (H), which can be advantageous in installing the tensioner in various motor configurations.

During normal tensioning, when a belt presses against a pulley attached to the arm 106, the arm will rotate about the pivot axis X₂ thereby winding the torsion spring. The torsional spring upon winding will apply spring torque against the arm to move, hold, or press the arm and pulley against the belt. When the arm rotates about the pivot axis X_{2,} winding the torsion spring, the frictional contact between a tensioner component and the damping mechanism reduces or acts to minimize the rotation of the arm in the un-tensioning direction. The damping mechanism's operative engagement with the arm herein provides frictional symmetric damping.

It should be noted that the embodiments are not limited in their application or use to the details of construction and arrangement of parts and steps illustrated in the drawings and description. Features of the illustrative embodiments, constructions, and variants may be implemented or incorporated in other embodiments, constructions, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

Having described the invention in detail and by reference to preferred embodiments thereof, it will be apparent that modifications and variations are possible without departing from the scope of the invention which is defined in the appended claims.

What is claimed is:

1. A high-offset belt tensioner comprising:
an end plate having a bore therethrough;
a pivot tube having a first end fixedly connect in the bore of the end plate and having a second end comprising an annular cup;
an arm seated over the annular cup of the pivot tube for rotation relative thereto and having a pully mount defining a pully rotation axis offset axially from the pivot tube; and
a flat wire torsion spring having an inner spring hook attached to the pivot tube and an outer spring hook attached to the arm at a position that counterbalances a hub load force acting in a first plane, wherein the flat wire torsion spring biases the arm in a belt engaging direction and applies a spring force acting on the arm in a second plane;
wherein a direction of the spring force acting on the arm stays in the same location with respect to the arm and moves with the arm throughout its entire sweep in the belt engaging direction, and the first plane is axially offset from a plane of the spring force.

2. The high-offset belt tensioner of claim 1, wherein the end plate is a powdered metal component and the pivot tube is cast aluminum component.

3. The high-offset belt tensioner of claim 1, wherein the bore of the end plate is a broached bore.

4. The high-offset belt tensioner of claim 1, further comprising a spring cover having an annular main body with a radially inward flange at a first end thereof, wherein the annular main body defines an open slot and is seated over the flat wire spring with the outer spring hook seated in the open slot.

5. The high-offset belt tensioner of claim 4, wherein the spring cover is a plastic component.

6. The high-offset belt tensioner of claim 5, wherein the plastic is a glass-filled nylon.

7. The high-offset belt tensioner of claim 4, wherein the annular main body of the spring cover is press-fit into the arm for rotation therewith and the radially inward flange has a contact seal against the upper surface of the end plate.

8. The high-offset belt tensioner of claim 7, wherein the radially inward flange is angled away from the annular main body.

9. The high-offset belt tensioner of claim 4, further comprising an annular lip seal seated between a rim of the spring cover and the arm for rotation therewith and having a lip flange in operative engagement with the annular cup of the pivot tube.

10. The high-offset belt tensioner of claim 1, further comprising a pivot bushing seated between an interior surface of the arm and an exterior surface of the annular cup of the pivot tube.

11. The high offset belt tensioner of claim 10, wherein the pivot bushing has a key that is keyed to the annular cup of the pivot tube.

12. The high-offset belt tensioner of claim 10, wherein the pivot bushing has a radially inward extending flange seated between an end surface of the annular cup of the pivot tube and a pivot-tube facing surface of the arm.

13. The high-offset belt tensioner of claim 1, further comprising a pivot bushing seated between an interior surface of the annular cup and a cup-facing surface of the arm seated inside the annular cup.

14. The high-offset belt tensioner of claim 13, wherein the pivot bushing has a radially outward extending flange seated between an end surface of the annular cup of the pivot tube and a pivot-tube facing surface of the arm.

15. The high offset belt tensioner of claim 14, wherein the pivot bushing has a key that is keyed to the arm.

16. The high-offset belt tensioner of claim 13, wherein the exterior surface of the annular cup has an arm travel limiting feature defining a preselected number of degrees for a maximum rotation of the arm and the arm has a mating feature engaged with the arm travel limiting feature.

17. The high-offset belt tensioner of claim 1, further comprising a damper bushing in operative engagement with the arm by an arm plate operatively engaging the second end of the pivot tube.

18. The high-offset belt tensioner of claim 17, wherein a wear surface of a main body of the damper bushing is seated against the arm plate and the main body includes a plurality of troughs for retention of grease, or the damper bushing and arm plate are seated in a cup defined by the arm with a rubber dust cover press-fit therein.

19. The high-offset belt tensioner of claim 1, wherein the arm has a radially protruding enclosure in its radially outermost surface at a position that locates the enclosure in a protective orientation over the outer spring hook.

20. The high-offset belt tensioner of claim 1, wherein the arm has an arm travel limiting feature defining a preselected number of degrees for a maximum rotation of the arm in a cup-facing surface of a cup-shaped portion seated in the annular cup of the pivot tube and the annular cup has a mating feature engaged with the arm travel limiting feature, or the annular cup has an arm travel limiting feature in the bottom surface thereof that defines a preselected number of degrees for a maximum rotation of the arm and the arm has a mating feature engaged with the arm travel limiting feature.
